(19) United States
(12) Patent Application Publication
(10) Pub. No.: US 2023/0081540 A1
(43) Pub. Date: Mar. 16, 2023

(54) MEDIA CLASSIFICATION

(71) Applicant: Hewlett-Packard Development Company, L.P., Spring, TX (US)

(72) Inventors: Sunil Ganpat Bharitkar, Palo Alto, CA (US); Andre da Fonte Lopes da Silva, Palo Alto, CA (US); Walter Flores Pereira, Palo Alto, CA (US)

(73) Assignee: Hewlett-Packard Development Company, L.P., Spring, TX (US)

(21) Appl. No.: 17/797,462

(22) PCT Filed: Mar. 13, 2020
(86) PCT No.: PCT/US2020/022618

§ 371 Date: Aug. 4, 2022

(51) Int. Cl. G06N 5/02; G06F 40/20

(52) U.S. Cl. CPC G06N 5/022; G06F 40/20

(57) ABSTRACT

Examples of methods for media classification are described herein. In some examples, a method includes analyzing text associated with media using a first machine learning model to produce a first result. In some examples, the method includes analyzing numerical metadata associated with the media using a second machine learning model to produce a second result. In some examples, the method includes inputting the first result and the second result to a third machine learning model to determine a classification of the media.

### BACKGROUND

Electronic technology has advanced to become virtually ubiquitous in society and has been used to improve many activities in society. For example, electronic devices are used to perform a variety of tasks, including work activities, communication, research, and entertainment. Electronic technology is often utilized to present media. For instance, computing devices may be utilized to present media that is streamed over a network. Electronic technology is also utilized to provide communication in the form of email, instant messaging, video conferencing, and Voice over Internet Protocol (VoIP) calls.

### BRIEF DESCRIPTION OF THE DRAWINGS

FIG. 1 is a flow diagram illustrating an example of a method for media classification;

FIG. 2 is a flow diagram illustrating an example of a method for media classification;

FIG. 3 is a block diagram of an example of an apparatus that may be used in media classification; and

FIG. 4 is a block diagram illustrating an example of a computer-readable medium for media classification.

### DETAILED DESCRIPTION

Electronic devices may be utilized to access and/or present media. Electronic devices are devices that include electronic circuitry. Media is audio content (e.g., sound, music, voice, etc.), visual content (e.g., digital images, text, etc.), or a combination thereof (e.g., audio-visual content such as videos). Multimedia is a combination of media. For example, multimedia may be a combination of visual content with audio content (e.g., movies, shows, music videos, lyric videos, advertisements, news, sports, etc.). A source is an entity that provides media. Some media sources (e.g., Internet websites, online platforms, local applications, etc.) may provide movies, music (e.g., music without visual content and/or music with visual content), voice, advertisements, news, sports, and/or user-generated content. Examples of sources may include Netflix, Amazon Prime Video, YouTube, YouTube TV, iTunes, Microsoft Store, Microsoft Teams, Zoom, GoToMeeting, Google, Cable News Network (CNN), Microsoft/National Broadcasting Company (MSNBC), Fox News, Empire and Sports Programming Network (ESPN), American Broadcasting Company (ABC), Columbia Broadcasting System (CBS), Disney+, National Broadcasting Company (NBC), Fox Sports, Spotify, iHeartMedia, Home Box Office (HBO), Smedio, Cyberlink, Windows Media Player, VideoLAN Client (VLC) media player, Mozilla-Firefox, Edge, Chrome, Internet Explorer, Lync, Skype, Xbox, PlayStation, Twitch, etc. For instance, YouTube, Vimeo, and Youku are examples of sources that provide movies, music, and user-generated content.

It may be beneficial to classify media into classes. A class is a category or type of media. In some examples, a class may refer to the subject and/or format of media. Some examples of classes may include a movie class, a music class, a voice class, an advertisement class, a news class, and/or a sports class. The movie class may include motion pictures, films, television shows, etc. The music class may include audio with or without video that expresses a musical work, song, tune, or piece. The voice class may include audio with or without video that expresses human voice for a call, meeting, conference, or communication. The advertisement class may include audio and/or video that expresses promotion of a good, product, service, or person. The news class may include audio and/or video that expresses news reporting. The sports class may include audio and/or video that expresses reporting and/or commentary of a sports event or events.

In some examples, classifying media may be performed to preserve artistic intent while rendering audio or audio-visual content. For example, some movies may be created with 5.1-channel surround sound or object-based audio, while some music (e.g., audio content with or without accompanying visual content) may be formatted in stereo before being encoded and transmitted to end consumer audio-visual (AV) devices such as televisions (TVs), set-top boxes, audio/video receivers (AVRs), personal computers (PCs), game consoles, smartphones, tablet devices and/or smart speakers. One issue is that an electronic device may utilize a spatial rendering engine that erroneously upmixes stereo music to 5.1 channels and presents the music with discrete 5.1-channel surround sound speakers or headphones. Other erroneous upmixing may result in presenting originally formatted stereo audio in 7.1-channel surround sound or 9.1 object-based audio. Erroneous upmixing may result in the loss of artistic intent and/or the introduction of spatial and/or timbre artifacts in music. Another issue that may occur is that an electronic device may present movies in stereo sound, which may lose the benefits of surround sound or object-based audio. It may be beneficial to classify media to utilize different settings (e.g., audio reproduction settings) for different classes. For example, it may be beneficial to utilize spatial filtering for three-dimensional (3D) audio and/or surround sound for media in the movie class. It may be beneficial to utilize equalization filters to enhance musical richness and/or vocals for media in the music class. It may be beneficial to enhance speech and/or dialog for media in the voice class (e.g., conferencing), advertisements class, and/or news class. Accordingly, it may be beneficial to classify media into a movie class, music class, voice class, advertisements class, news class, and/or sports class, etc. Classifying media may also be beneficial for multimedia indexing, real-time identification, and/or retrieval. Automatically classifying media may be beneficial by avoiding manual user selection of a media classification. For instance, classifying media may be utilized to enable automatic selection of settings (e.g., audio reproduction settings) without user intervention.

Throughout the drawings, identical reference numbers may designate similar, but not necessarily identical, elements. Similar numbers may indicate similar elements. When an element is referred to without a reference number, this may refer to the element generally, without necessary limitation to any particular figure. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

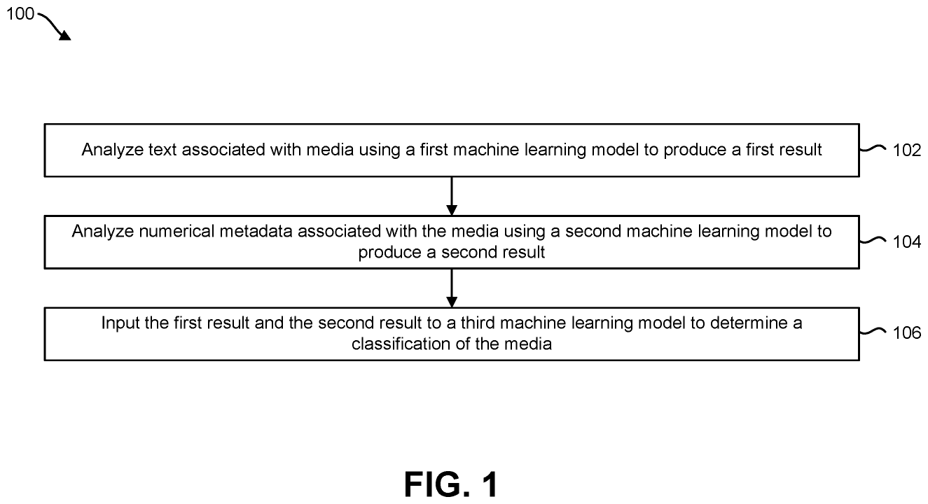

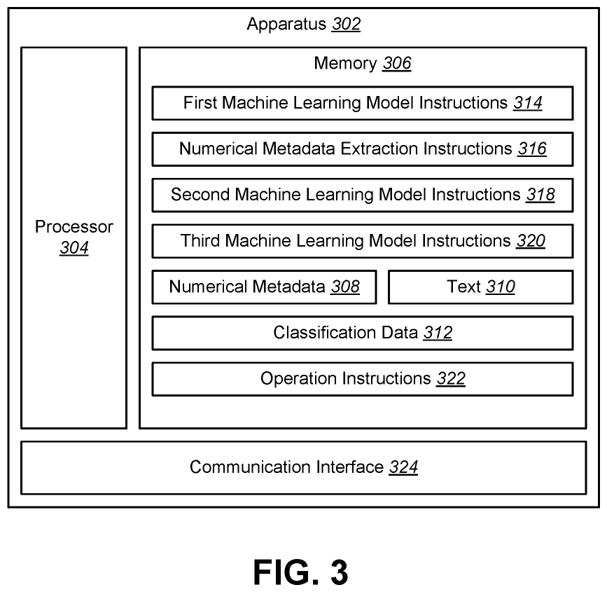

FIG. 1 is a flow diagram illustrating an example of a method 100 for media classification. The method 100 and/or a method 100 element or elements may be performed by an apparatus (e.g., electronic device, computing device, TV, set-top box, AVR, PC, smart speakers, home theater, smartphone, tablet device, media server, etc.). For example, the method 100 may be performed by the apparatus 302 described in connection with FIG. 3.

The apparatus may analyze 102 text associated with media using a first machine learning model to produce a first result. Text associated with media is or are text that describe the media. For instance, the text may describe the subject, meaning, or substance of the media. For example, text may include letters (e.g., word(s), phrase(s), sentence(s), paragraph(s), etc.) that describe media (e.g., video(s), audio recording(s), audio-visual content, etc.). Examples of text may include title(s), keyword(s), description(s), comment(s), label(s), name(s), artist(s), etc. In some examples, text for media may be stored including a title, a description, keywords, and/or other text for each of the media (in a table, for instance). For example, text for a video with an identifier may include a title such as “Best Cars of 2019,” a description such as “Our review of the best vehicles in the 2019 model year,” and keywords such as “car,” “review,” “motoring,” and makes of cars shown in the video. In some examples, the text may be utilized in a natural language processing technique or techniques. In some examples, text may or may not include numbers. In some examples, text may accompany media. For example, a site (e.g., a streaming website, a webpage, a file on a network, etc.) and/or an application may provide text associated with media (e.g., a media stream). In some examples, text may be stored with a media file. For instance, text may reside in a header of a local or streaming video file (e.g., QuickTime file). An apparatus may obtain (e.g., receive and/or access) the text associated with media. For example, an apparatus may receive text (e.g., text in hypertext markup language (HTML), extensible markup language (XML), etc.) from a streaming website and/or may read text in a media file. In some examples, text may be included as metadata with media.

Machine learning is a technique where a machine learning model is trained to perform an operation based on examples or training data. For example, an apparatus may utilize a machine learning model or machine learning models that are trained to classify media based on text and/or metadata associated with the media. Examples of machine learning models may include artificial neural networks, fully connected neural networks (FCNNs), long short-term memory (LSTM) models, support vector machines, random forests, decision trees, etc. In some examples, training a machine learning model may include adjusting a weight or weights of the machine learning model (e.g., neural network(s)) based on training data. For example, the weight(s) may be adjusted to reduce or minimize losses, which may be calculated using a loss function. In some examples, a machine learning model may be periodically, repeatedly, and/or continuously updated and/or trained based on results and/or feedback.

The first machine learning model may produce the first result based on text associated with the media. In some examples, the first result may include a first probability value or values corresponding to a class or classes of media. A probability value is a numeric value that indicates a probability or likelihood. For instance, the first result may include first probability values corresponding to a movie class, a music class, a voice class, an advertisement class, and/or a sports class. For example, each of the probability values may indicate a probability or likelihood that the media associated with the text belongs to a class (e.g., movie class, music class, voice class, advertisement class, sports class, etc.). In some examples, the first results may be expressed as a vector. For instance, the probability values produced by the first machine learning model may be expressed as a vector, where each vector component is a probability value corresponding to a different class. In some examples, the first machine learning model may be implemented as a support vector machine model, an LSTM model, an FCNN model, a random forest model, etc.

In some examples, analyzing 102 the text may include removing punctuation and/or word(s) from the text. For example, the apparatus may parse the text and remove stop words from the text. A stop word is a word with little meaning in the text. Examples of stop words may include “the,” “a,” “and,” “an,” etc. In some examples, the apparatus may remove punctuation (e.g., period(s), comma(s), semicolon(s), quotation mark(s), parentheses, etc.). In some examples, the apparatus may utilize an application programming interface (API) to parse text fields in a data structure (e.g., spreadsheet, table, list, etc.) to remove the punctuation and/or word(s) from text in the text fields corresponding to media.

In some examples, analyzing 102 the text may include mapping the text (e.g., the text with word(s) and/or punctuation removed) to a vector of numerical values. For example, the apparatus may map the text into a space (e.g., words of the text to locations in the space), where the mapping indicates similarity and/or difference between words. For example, a distance between words in the space may represent a degree of similarity or difference between the words. In some examples, the apparatus may utilize a machine learning model or models (e.g., neural network(s)) or mapping function to map the text to the vector of numeric values. In some examples, the apparatus may utilize a global vectors technique to map the text to the vector of numerical values.

In some examples, analyzing 102 the text may include inputting the text or information based on the text to the first machine learning model to produce the first result. For example, the apparatus may input the vector of numerical values to the first machine learning model to produce the first result.

In some examples, analyzing 102 the text may include performing a natural language processing technique or techniques. In some examples, removing punctuation and/or word(s) from the text may be an example of a natural language processing technique. In some examples, mapping the text to a vector of numerical values may be an example of a natural language processing technique. In some examples, the text may be mapped to the vector of numerical values using Global Vector Embedding (GloVe). In some examples, inputting the text and/or information based on the text (e.g., vector of numerical values based on the text) to the first machine learning model may be an example of a natural language processing technique.

In some examples, the first machine learning model may be trained by the apparatus and/or may be trained by another device. For example, the first machine learning model may be pre-trained by another device, and the apparatus may receive and/or store the pre-trained first machine learning model from the other device.

In some examples, the first machine learning model may be trained based on training text associated with a set of training media and labels corresponding to the set of training media. For example, a set of training media may be a set of media that is labeled by class. For instance, each label may specify or indicate a class (e.g., a text label or a number label corresponding to a class). In some approaches, the set of training media may be manually labeled and/or may be automatically generated. In some examples, the set of training media may be utilized as ground truth for training. In some examples, text and numerical metadata for training a machine learning model or models may be stored in a table, spreadsheet, and/or may reside in a video container (e.g., Moving Picture Experts Group 4 (MPEG-4) headers or descriptors). For example, the table and/or spreadsheet may include a class, title, description, keywords, numerical vector (determined from text, for instance), duration, sample rate, video presence indicator, bit depth, number of channels, and/or probability values for each media item (e.g., video, clip, etc.). In some examples, the text may include the description and keywords. In some examples, the numerical metadata may include duration, sample rate, video presence indicator, bit depth, and/or number of channels. In some examples, data for classified media (e.g., results) may be stored in a table and/or spreadsheet including data similar to that of the table and/or spreadsheet described for training.

The training text may be a set of text (e.g., word(s), phrase(s), sentence(s), paragraph(s), title(s), keyword(s), description(s), comment(s), label(s), name(s), artist(s), etc.) that describe the set of training media. The training text or information (e.g., training vectors of numerical values) based on the training text may be utilized as input for training. In some examples, the training text may be processed for training. For example, the apparatus or another device may remove punctuation and/or word(s) from the training text, and/or may map the training text to a training vector or vectors of numerical values.

The apparatus may analyze 104 numerical metadata associated with media using a second machine learning model to produce a second result. Metadata is data about media. In some examples, metadata may be stored with and/or may be communicated (e.g., transmitted and/or received) with the media. In some examples, metadata may include content-related descriptors in encoded music and visual media content (e.g., in Moving Picture Experts Group-4 (MP4) files or other files) that may be extracted by decoding media content or a portion of the media content. Different types of metadata may describe different aspects of media. For example, some metadata may describe media format and/or how media is stored, and some metadata may describe the substance of the media. For example, some metadata may include video/audio codec, content duration, video/audio bitrate, bit-depth, sample rate for audio, and/or frames/second (e.g., for moving pictures), etc. Some metadata may include language, title, artist (if applicable), album cover image, etc. Different containers may include different metadata descriptors. A container is a file that includes content (e.g., audio content and/or visual content) and metadata. While the metadata descriptors may be different between different containers (e.g., MP4, QuickTime Movie (MOV), Audio Video Interleave (AVI), etc.), some metadata descriptors may be included in a variety of containers. For example, some metadata descriptors may include duration (e.g., running time or length of the content), sample rate (e.g., sample rate of audio), video presence (e.g., presence or absence of video), bit depth (e.g., audio bit depth), number of channels (e.g., audio channel count), video frame rate, etc. In some examples, it may be beneficial to utilize a subset of available metadata to efficiently train a machine learning model. In some examples, a vector for the machine learning model may include duration, sample rate, video presence, bit depth, and/or number of channels.

Numerical metadata is metadata that includes numbers. For instance, numerical metadata may specify a numerical attribute or attributes of the format of the media. Examples of numerical metadata may include content duration, sample rate, video presence, bit depth, number of audio channels, video frame rate, etc. Other kinds of numerical metadata may be utilized in some examples. Numerical metadata associated with media is a number or numbers that describe the media. For example, numerical metadata may include numbers or quantities (e.g., integer(s), floating point number(s), and/or numerical indicator(s), etc.) that describe a format of media (e.g., video(s), audio recording(s), audio-visual content, etc.). Examples of numerical metadata may include duration (e.g., length in time), sample rate, video presence, bit depth, number of channels, etc. In some examples, numerical metadata may not include letters. In some examples, numerical metadata may accompany media. For example, a streaming website or application may provide numerical metadata associated with media (e.g., a media stream). In some examples, numerical metadata may be stored with a media file. An apparatus may obtain (e.g., receive and/or access) the numerical metadata associated with media. For example, an apparatus may receive numerical metadata from a streaming website and/or may read numerical metadata in a media file.

The second machine learning model may produce the second result based on numerical metadata associated with the media. In some examples, the second result may include a second probability value or values corresponding to a class or classes of media. For instance, the second result may include second probability values corresponding to a movie class, a music class, a voice class, an advertisement class, and/or a sports class. For example, each of the probability values may indicate a probability or likelihood that the media associated with the numerical metadata belongs to a class (e.g., movie class, music class, voice class, advertisement class, sports class, etc.). In some examples, the second results may be expressed as a vector. For instance, the probability values produced by the second machine learning model may be expressed as a vector, where each vector component is a probability value corresponding to a different class. In some examples, the second machine learning model may be implemented as a support vector machine model, an FCNN model, a random forest model, etc. In some examples, the first result includes first probability values and the second result includes second probability values corresponding to a same set of classes. For example, the first probability values may include a first set of values for the set of classes and the second probability values may include a second set of values for the set of classes.

In some examples, analyzing 104 the numerical metadata may include extracting the numerical metadata. In some examples, the apparatus may read and/or decode a portion of a media container to extract the numerical metadata. In some examples, the apparatus may read and/or store the metadata from a page document corresponding to media. In some examples, the apparatus may read and/or store metadata associated with the media file handle.

In some examples, analyzing 104 the numerical metadata may include inputting the numerical metadata or information based on the numerical metadata to the second machine learning model to produce the second result. For example, the apparatus may input a vector of numerical metadata values to the second machine learning model to produce the second result.

In some examples, the second machine learning model may be trained by the apparatus and/or may be trained by another device. For example, the second machine learning model may be pre-trained by another device, and the apparatus may receive and/or store the pre-trained second machine learning model from the other device.

In some examples, the second machine learning model may be trained based on training numerical metadata associated with a set of training media and labels corresponding to the set of training media. For example, a set of training media may be a set of media that is labeled by class. For instance, each label may specify or indicate a class (e.g., a text label or a number label corresponding to a class). In some approaches, the set of training media may be manually labeled and/or may be automatically generated. In some examples, the set of training media for training the second machine learning model may be the same as or different from the set of training media for training the first machine learning model. In some examples, the set of training media may be utilized as ground truth for training.

The training numerical metadata may be a set of numerical metadata (e.g., numbers, quantities, values, etc.) corresponding to the set of training media. The training numerical metadata or information (e.g., training vectors of numerical metadata values) based on the training numerical metadata may be utilized as input for training.

The apparatus may input 106 the first result and the second result to a third machine learning model to determine a classification of the media. For example, the apparatus may input 106 the first result from the first machine learning model and the second result from the second machine learning model to the third machine learning model. In some examples, inputting the first result and the second result may include inputting first probability values and second probability values to the third machine learning model. In some examples, the first probability values and the second probability values each include values corresponding to a set of classes. For example, the first probability values and the second probability values may each include values corresponding to a movie class, a music class, a voice class, an advertisement class, a news class, and/or a sports class, etc.

The third machine learning model may produce the third result based on the first result and the second result associated with the media. In some examples, the third result may include a third probability value or values corresponding to a class or classes of media. For instance, the third result may include third probability values corresponding to a movie class, a music class, a voice class, an advertisement class, and/or a sports class. For example, each of the probability values may indicate a probability or likelihood that the media associated with the first results and the second results belongs to a class (e.g., movie class, music class, voice class, advertisement class, sports class, etc.). In some examples, the third results may be expressed as a vector. For instance, the probability values produced by the third machine learning model may be expressed as a vector, where each vector component is a probability value corresponding to a different class. In some examples, the third machine learning model may be implemented as a support vector machine model, an FCNN model, a random forest model, a decision tree model, etc. In some examples, the first result includes first probability values, the second result includes second probability values and the third result includes third probability values corresponding to a same set of classes. For example, the first probability values may include a first set of values for the set of classes, the second probability values may include a second set of values for the set of classes, and the third probability values may include a third set of values for the set of classes.

In some examples, the third machine learning model may produce third probability values. In some examples, determining the classification may include selecting a class corresponding to a greatest value of the third probability values. For example, the apparatus may compare and/or rank the third probability values, and may select the class that corresponds to a greatest, highest, or maximum probability within the third probability values. The selected class may be the determined classification for the media.

In some examples, the third machine learning model may be trained by the apparatus and/or may be trained by another device. For example, the third machine learning model may be pre-trained by another device, and the apparatus may receive and/or store the pre-trained third machine learning model from the other device.

In some examples, the third machine learning model may be trained based on first training probability values, second training probability values, and labels corresponding to a set of training media. In some examples, the first training probability values may correspond to the first machine learning model (e.g., may be produced by the first machine learning model). For example, the first training probability values may be probability values corresponding to classes of media (e.g., movie class, music class, voice class, advertisement class, news class, and/or sports class, etc.) for training text corresponding to a set of training media. In some examples, the second training probability values may correspond to the second machine learning model (e.g., may be produced by the second machine learning model). For example, the second training probability values may be probability values corresponding to classes of media (e.g., movie class, music class, voice class, advertisement class, news class, and/or sports class, etc.) for training numerical metadata corresponding to a set of training media. In some examples, a set of training media may be a set of media that is labeled by class. For instance, each label may specify or indicate a class (e.g., a text label or a number label corresponding to a class). In some approaches, the set of training media may be manually labeled and/or may be automatically generated. In some examples, the set of training media for training the third machine learning model may be the same as or different from the set of training media for training the first machine learning model and/or may be the same as or different from the set of training media for training the second machine learning model. In some examples, the set of training media may be utilized as ground truth for training. The first probability values and the second probability values may be utilized as input for training.

In some examples, the third machine learning model may be a fusion model utilized to combine or fuse the first results from the first machine learning model and the second results from the second machine learning model. For example, the third machine learning model may be utilized to fuse results from a model (e.g., the first machine learning model) that classifies based on text and a model (e.g., the second machine learning model) that classifies based on numerical metadata. In some examples, the third machine learning model may classify the media after the first machine learning model and the second machine learning model have classified the media. The first machine learning model and the second machine learning model may perform classification concurrently (e.g., in overlapping time frames) or in sequence (e.g., one after the other).

In some examples, classifying the media using a combination of machine learning models (e.g., the first machine learning model, the second machine learning model, and the third machine learning model) may increase accuracy relative to using one machine learning model. For instance, utilizing a combination of machine learning models may reduce errors. For example, errors in a confusion matrix may be reduced, where the confusion matrix may indicate misclassification results from a machine learning model on the input data. In some examples, utilizing text and numerical metadata to classify media may be beneficial by increasing classification speed and/or accuracy. For instance, some techniques that classify media utilizing text and/or metadata may offer better classification speed, lower latency, better accuracy (e.g., 80-90% or better), and/or reduced processing usage relative to waveform-based (e.g., optical data and/or audio waveform) classification. In some examples, an amount of time or delay to classify the media may be (e.g., 6-8 milliseconds (ms) for machine learning model processing and approximately 50 ms for streaming and API processing), to reduce processing resource usage (e.g., approximately 1%) to classify the media, and/or to increase classification accuracy (e.g., 90% accuracy). Utilizing a combination of text and numerical metadata to classify media may be beneficial by enabling discrimination of overlapping numerical metadata distributions. For instance, some techniques may enable distinguishing between movie trailers and advertisements, which may have roughly similar durations, sample rates, bit depths, and/or number of audio channels (e.g., 2) at streaming websites.

In some examples, little or no text corresponding to the media may be available, so the second result (based on the numerical metadata, for instance) may contribute more significantly to the third machine learning model. In some examples, some numerical metadata may not be available, so the first result and the second result (from the first machine learning model and the second machine learning model) may contribute to the third machine learning model.

In some examples, an element or elements of the method 100 may be omitted or combined. In some examples, the classification and/or the method 100 may be performed without waveform-based analysis or classification. For example, it may be beneficial to classify media based on text and/or metadata (and not based on content waveforms, for instance) to reduce an amount of time or delay to classify the media. In some examples, the classification may be performed without applying machine learning to an audio waveform or samples, and/or without applying machine learning to pixel data (e.g., frame data, visual image data).

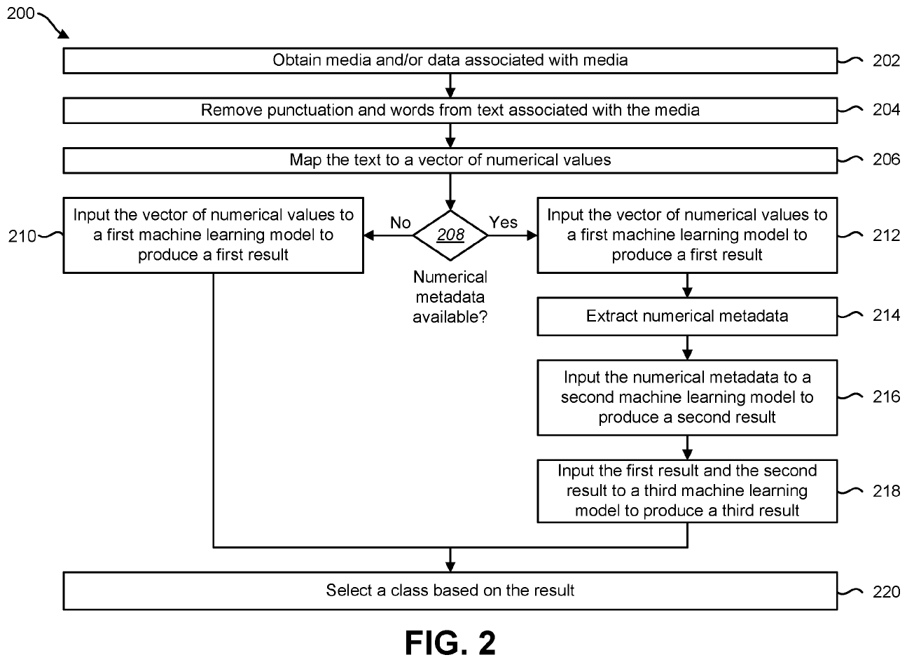

FIG. 2 is a flow diagram illustrating an example of a method 200 for media classification. The method 200 may be an example of the method 100 described in connection with FIG. 1. The method 200 and/or an element or elements of the method 200 may be performed by an apparatus (e.g., electronic device, computing device, server, etc.). For example, the method 200 may be performed by the apparatus 302 described in connection with FIG. 3.

The apparatus may obtain 202 media and/or data associated with media. For example, the apparatus may request and/or receive media from another device (e.g., a server via the Internet, a device on a local area network (LAN), etc.) and/or may load the media from internal storage or external storage (e.g., external hard drive, thumb drive, digital video disc (DVD), Blu-ray disc, etc.). In some examples, the apparatus may request and/or receive data (e.g., text and/or metadata) associated with media and/or may load data (e.g., text and/or metadata) associated with media from internal storage or external storage. For instance, the apparatus may obtain media from a website or web service (e.g., YouTube, Vimeo, Dailymotion, etc.).

The apparatus may remove 204 punctuation and words from text associated with the media. In some examples, the apparatus may remove 204 punctuation and words from the text as described in relation to FIG. 1. For instance, the apparatus may parse the text and remove periods, semicolons, commas, etc., and/or may remove stop words.

The apparatus may map 206 the text to a vector of numerical values. In some examples, the apparatus may map 206 the text to a vector of numerical values as described in relation to FIG. 1. For instance, the apparatus may map 206 the text (e.g., text with punctuation and stop words removed) to a vector of numerical values using a neural network and/or a mapping function.

The apparatus may determine 208 whether numerical metadata is available. For example, the apparatus may determine whether numerical metadata is available through a browser and/or media file. In a case that the media corresponds to a browser process, for example, the apparatus may download a page document using a uniform resource locator (URL) corresponding to the media and determine whether metadata (e.g., numerical metadata) associated with the media is included in the page document. In a case that the media does not correspond to a browser process, the apparatus may utilize a media file handle to determine whether metadata (e.g., numerical metadata) is associated with the media. In some examples, the apparatus may determine that numerical metadata is available if the page document includes numerical metadata and/or if a media file indicated by the media file handle includes numerical metadata.

In response to determining 208 that the numerical metadata is not available, the apparatus may input 210 the vector of numerical values to a first machine learning model to produce a first result. In some examples, the apparatus may input 210 the vector of numerical values to the first machine learning model as described in relation to FIG. 1. For example, the apparatus may input a vector of numerical values based on the text to the first machine learning model. The apparatus may execute the first machine learning model to produce the first result.

The apparatus may select 220 a class based on the result. For example, the first result may include first probability values corresponding to a set of classes (e.g., movie class, music class, voice class, advertisement class, news class, sports class, etc.). The apparatus may select a class corresponding to a greatest probability value of the first probability values.

In response to determining 208 that the numerical metadata is available, the apparatus may input 212 the vector of numerical values to a first machine learning model to produce a first result. In some examples, the apparatus may input 212 the vector of numerical values to the first machine learning model as described in relation to FIG. 1. For example, the apparatus may input a vector of numerical values based on the text to the first machine learning model. The apparatus may execute the first machine learning model to produce the first result. In some examples, the first result may include first probability values (e.g., a vector of first probability values) corresponding to a set of classes.

The apparatus may extract 214 numerical metadata. In some examples, the apparatus may read and/or store metadata (e.g., numerical metadata) from a page document corresponding to the media. In some examples, the apparatus may read and/or store metadata (e.g., numerical metadata) associated with a media file handle (e.g., from a media file indicated by the media file handle). In some examples, the apparatus may format the numerical metadata. For instance, the apparatus may format the numerical metadata into a vector. In some examples, the apparatus may select a type or types of numerical metadata. For instance, the apparatus may include duration, sample rate, video presence, bit depth, and/or number of channels in the vector.

The apparatus may input 216 the numerical metadata to a second machine learning model to produce a second result. In some examples, the apparatus may input 216 the vector (of numerical metadata values, for instance) to the second machine learning model as described in relation to FIG. 1. For example, the apparatus may input a vector of numerical metadata values to the second machine learning model. The apparatus may execute the second machine learning model to produce the second result. In some examples, the second result may include second probability values (e.g., a vector of second probability values) corresponding to a set of classes.

The apparatus may input 218 the first result and the second result to a third machine learning model to produce a third result. In some examples, the apparatus may input 218 the first result (e.g., first probability values) and the second result (e.g., second probability values) to the third machine learning model as described in relation to FIG. 1. For example, the apparatus may input a vector of numerical metadata values to the third machine learning model. The apparatus may execute the third machine learning model to produce the third result. In some examples, the third result may include third probability values (e.g., a vector of third probability values) corresponding to a set of classes.

The apparatus may select 220 a class based on the result. For example, the third result may include third probability values corresponding to a set of classes (e.g., movie class, music class, voice class, advertisement class, news class, sports class, etc.). The apparatus may select a class corresponding to a greatest probability value of the third probability values.

In some examples, the apparatus may perform an operation based on the selected 220 class. For example, the apparatus may store a record of the classification of the media. The apparatus may utilize the record to respond to a request (e.g., user request for a class of media), to recommend media (e.g., to provide a recommendation to a user with a profile that indicates a preference for the class of media), to tag the media (e.g., to add a keyword, label, or tag to the media indicating the media class), etc.

In some examples, the apparatus may select an audio setting based on the classification (e.g., the selected 220 class). For example, the apparatus may include a set of audio settings (e.g., pre-sets) for classes of media. In some examples, different audio settings may be utilized for different media classes (e.g., movies, advertisements, sports, news, music, voice, etc.). For instance, the set of audio settings may include a surround setting, a stereo setting, a speech setting, an amplification setting, an attenuation setting, etc. In some examples, the apparatus may utilize a surround setting for the movie class, may utilize the stereo setting for the music class, or may utilize the speech setting for the voice class, the advertisements class, the news class, and/or the sports class. In some examples, the apparatus may utilize the amplification setting or the attenuation setting for advertisements (e.g., for the advertisements class). Other examples may include more or fewer settings and/or may utilize different settings for each of the classes.

In some examples, the surround setting may provide surround sound (e.g., spatial filters, more than two speaker channels, 5.1-channel surround sound, 7.1-channel surround sound, object-based audio, and/or 9.1-channel surround sound, etc.). In some examples, using a surround sound setting may include processing and/or presenting the media using synthetic surround sound. For instance, the apparatus may upmix the audio of the media to more than two channels and/or present the audio using more than two speakers. In some examples, the stereo setting may provide stereo sound (e.g., two speaker channels, equalization filter(s), vocal enhancement). For instance, using a stereo setting may include processing and/or presenting the audio of the media using two channels and/or two speakers. In some examples, the speech setting may provide enhanced speech (e.g., filtering to enhance speech clarity). In some examples (e.g., for VoIP, conference calls, etc.) of the voice class, the apparatus may use a monophonic setting. In some examples, using a monophonic setting may include processing (e.g., speech enhancing filtering) and/or presenting the audio using one audio channel comprising voice from a talker or multiple talkers. In some examples of the news class, advertisements class, or sports, the apparatus may use a stereo setting. In some examples, an element or elements of the method 200 may be omitted or combined.

FIG. 3 is a block diagram of an example of an apparatus 302 that may be used in media classification. The apparatus 302 may be an electronic device, such as a PC, server computer, TV, set-top box, AVR, smart speakers, home theater, media server, game console, etc.). The apparatus 302 may include and/or may be coupled to a processor 304 and/or a memory 306. The apparatus 302 may include additional components (not shown) and/or some of the components described herein may be removed and/or modified without departing from the scope of this disclosure.

The processor 304 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions (e.g., executable code) stored in the memory 306. The processor 304 may fetch, decode, and/or execute instructions stored in the memory 306. In some examples, the processor 304 may include an electronic circuit or circuits that include electronic components for performing a function or functions of the instructions. In some examples, the processor 304 may be implemented to perform one, some, or all of the functions, operations, elements, methods, etc., described in connection with one, some, or all of FIGS. 1-4.

The memory 306 is an electronic, magnetic, optical, and/or other physical storage device that contains or stores electronic information (e.g., instructions and/or data). The memory 306 may be, for example, Random Access Memory (RAM), Electrically Erasable Programmable Read-Only Memory (EEPROM), a storage device, an optical disc, and/or the like. In some examples, the memory 306 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some implementations, the memory 306 may be a non-transitory tangible machine-readable storage medium, where the term “non-transitory” does not encompass transitory propagating signals. In some examples, the memory 306 may include multiple devices (e.g., a RAM card and a solid-state drive (SSD)).

In some examples, the apparatus 302 may include a communication interface 324 through which the processor 304 may communicate with a device or devices (e.g., speakers, headphones, monitors, TVs, display panels, server, computer, network device, etc.). In some examples, the apparatus 302 may be in communication with (e.g., coupled to, have a communication link with) speakers. In some examples, the apparatus 302 may be a PC, server computer, TV, set-top box, AVR, smart speakers, home theater, media server, etc.

In some examples, the communication interface 324 may include hardware and/or machine-readable instructions to enable the processor 304 to communicate with the external device or devices. The communication interface 324 may enable a wired and/or wireless connection to the external device or devices. In some examples, the communication interface 324 may include a network interface card and/or may also include hardware and/or machine-readable instructions to enable the processor 304 to communicate with various input and/or output devices. Examples of output devices include a printer, a 3D printer, a display, etc. Examples of input devices include a keyboard, a mouse, a touch screen, etc., through which a user may input instructions and/or data into the apparatus 302. In some examples, the communication interface 324 may enable the apparatus 302 to communicate with a device or devices (e.g., servers, computers, etc.) over a network or networks. Examples of networks include the Internet, wide area networks (WANs), local area networks (LANs), personal area networks (PANs), and/or combinations thereof. For example, the apparatus 302 may send requests for media to a website or websites on the Internet and/or may receive a media stream or streams from the website(s).

In some examples, the memory 306 of the apparatus 302 may store first machine learning model instructions 314, numerical metadata extraction instructions 316, second machine learning model instructions 318, third machine learning model instructions 320, numerical metadata 308, text 310, classification data 312, and/or operation instructions 322. In some examples, the memory 306 may include a training data set for training a machine learning model or models.

The processor 304 may determine a first set of probability values using a first machine learning model based on text 310 associated with media. For example, the processor 304 may obtain and/or store text 310 associated with media (e.g., video stream, media file, etc.). In some examples, the processor 304 may remove punctuation and/or stop words from the text 310, and/or may map the text 310 to a numerical vector. In some examples, the processor 304 may execute the first machine learning model instructions 314 based on the text 310 (e.g., numerical vector based on the text 310) to determine the first set of probability values. The first set of probability values may be included in and/or stored as classification data 312. In some examples, determining the first set of probability values may be performed as described in relation to FIG. 1 and/or FIG. 2.

The processor 304 may extract numerical metadata 308 associated with the media. For example, the processor 304 may execute the numerical metadata extraction instructions 316 to extract the numerical metadata associated with the media. In some examples, the processor 304 may execute the numerical metadata extraction instructions 316 to extract numerical metadata 308 from a page document corresponding to a website that is providing a media stream. In some examples, the processor 304 may execute the numerical metadata extraction instructions 316 to extract numerical metadata 308 associated with a media file handle corresponding to a local process. The extracted numerical metadata 308 may be stored in the memory 306. In some examples, the numerical metadata 308 may include data (e.g., descriptors) indicating duration, sample rate, video presence, bit depth, and/or number of channels for media. In some examples, extracting the numerical metadata may be performed as described in relation to FIG. 1 and/or FIG. 2.

The processor 304 may determine a second set of probability values using a second machine learning model based on the numerical metadata 308 associated with media. For example, the processor 304 may execute the second machine learning model instructions 318 based on the numerical metadata 308 to determine the second set of probability values. The second set of probability values may be included in and/or stored as classification data 312. In some examples, determining the second set of probability values may be performed as described in relation to FIG. 1 and/or FIG. 2.

In some examples, the second machine learning model may be trained using data indicating duration, sample rate, video presence, bit depth, and/or number of channels of media. For example, the second machine learning model may be trained using examples of duration, sample rate, video presence, bit depth, and/or number of channels corresponding to labeled media. In some examples, the training may be performed by the apparatus 302. In some examples, the training may be performed by another device and the trained second machine learning model may be provided to the apparatus 302.

In some examples, duration metadata may be utilized for the machine learning model. For example, duration metadata may be characterized by a content-dependent distribution ƒ_{c}(x|a, b), where c represents the class or classification (e.g., movie, music, voice, advertisement, news, sports), x is the duration in seconds, and a and b are parameters of the distribution. In some examples, samples representing the duration metadata may be generated in accordance with the distribution. In some examples, the duration metadata may be synthetically generated to train a machine learning model. It may be beneficial to synthetically generate the duration metadata to avoid sampling a large number of media. In some examples, it may be beneficial to synthetically generate the duration metadata to enable adjusting the distribution parameters to improve classification accuracy of a machine learning model. For instance, samples of duration may be obtained corresponding to music, movie trailers, movies, short form films, long form films, TV shows, broadcast sports, etc. Some examples of the duration metadata distribution may include a Weibull distribution (based on asymmetric nature of the independent variable being modeled, for instance) and a Gaussian distribution. For example, a Weibull distribution may be parameterized by (α, β) on a domain t (in seconds, for example) that control the position and the shape of the distribution, and may be expressed in accordance with Equation (1).

$$f ( t \vert α , β ) = \frac{β}{α} {( \frac{t}{α} )}^{β - 1} {e}^{{( - \frac{t}{α} )}^{β}} \qquad ( 1 )$$

In Equation (1), ƒ_{c}(x|a, b) is a Weibull distribution, where t is time, and α and β are parameters that control the position and shape of the distribution. For instance, the content-dependent distribution ƒ_{c}(x|a, b) may be an example of the distribution ƒ(t|α, β).

A Gaussian distribution may be expressed in accordance with Equation (2).

$$f ( t \vert α , β ) = \frac{1}{\sqrt{2 π} β} {e}^{- {( \frac{t - α}{β} )}^{2}} \qquad ( 2 )$$

In Equation (2), ƒ(t|α, β) is a Gaussian distribution, where t is time, and α and β are parameters that control the position and shape of the distribution. For instance, the content-dependent distribution ƒ_{c}(x|a, b) may be an example of the distribution ƒ(t|α, β). In some examples, metadata (e.g., content duration metadata) generated with the distribution may be utilized to train a machine learning model for classifying the media. For instance, a distribution or distributions of metadata may be generated for each class or classification (e.g., movie, music, voice, advertisement, news, sports) to produce a training data set.

In some examples, feature vectors may be generated to train a second machine learning model. For example, feature vectors may be generated that include one of three sample rates corresponding to 48 kilohertz (kHz), 44.1 kHz, and 16 kHz, which may be used for movies (e.g., audio-visual content), music, user-generated content, and/or voice (e.g., VoIP calls). In some examples, each of the feature vectors may include a binary variable (e.g., 0 or 1) indicating the presence or absence of video. In some examples, each of the feature vectors may include a parameter corresponding to a quantized bit-depth of 16 bits/sample (for voice, music, or movies, for instance), 20 bits/sample (for broadcast content, for instance), and 24 bits/sample (for movies, for instance). In some examples, each of the feature vectors may include a number of channels (e.g., 1 for monophonic content, 2 for stereo content, or 6 for surround sound content).

In some examples, the second machine learning model may be a multilayered fully connected neural network (FCNN). For instance, an FCNN may have an approximation property that enables approximating arbitrary functions (e.g., non-linear boundaries). In some examples, the multilayered FCNN may include two hidden layers, with 30 and 40 neurons respectively, and an output layer of three neurons corresponding to the classifications. In some examples, the training of the multilayer FCNN weights w may be performed with a weight update rule involving the first derivative of network error e with respect to weights and biases (according to a Jacobian matrix J) being set in accordance with Equation (3).

w(k+1)=w(k)−(J^{T}J+μI)⁻¹J^{T}e (3)

In Equation (3), w(k) is a weight with index k, J is the Jacobian matrix, T denotes transpose, μ is a regularization parameter to allow stable inversion of the matrix (J^{T}J), and e is the network error.

The processor 304 may determine a classification of the media using a third machine learning model based on the first set of probability values and the second set of probability values. For example, the processor 304 may execute the third machine learning model instructions 320 based on the first set of probability values and the second set of probability values to determine a third set of probability values. The third set of probability values may be included in and/or stored as classification data 312. The processor 304 may select a class (e.g., movie class, music class, voice class, advertisement class, news class, sports class) based on the third set of probability values as the classification of the media. In some examples, the apparatus 302 (e.g., processor 304) may store a record of the class or classification as classification data 312 in the memory 306. In some examples, determining the third set of probability values and/or classification may be performed as described in relation to FIG. 1 and/or FIG. 2.

In some examples, the processor 304 may execute the operation instructions 322 to perform an operation with the classification. In some examples, the processor 304 may select an audio setting based on the classification as described above. In some examples, the apparatus 302 (e.g., processor 304) may present the media with the selected audio setting. For example, the apparatus 302 may process (e.g., filter, transform, equalize, etc.) media audio and/or provide media audio to an integrated and/or remote speaker or speakers based on the selected audio setting. In some examples, the apparatus 302 (e.g., processor 304) may provide the media to an integrated and/or remote display to display the media (e.g., video, image(s), etc.). In some examples, the apparatus 302 (e.g., processor 304) may provide the media or a representation (e.g., listing) of the media with the determined classification for display. In some examples, the apparatus 302 (e.g., processor 304) may provide search results and/or a recommendation for media based on the classification. For instance, the apparatus 302 (e.g., processor 304) may indicate (e.g., send for display, output sound for, send an indication to another device, etc.) media with a classification matching a requested classification and/or a recommended classification.

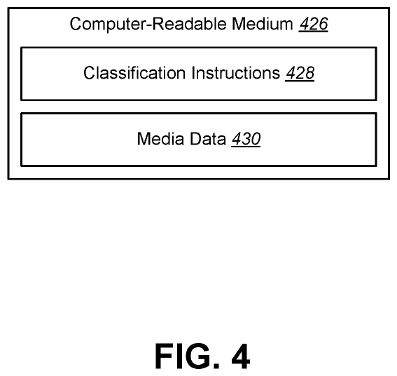

FIG. 4 is a block diagram illustrating an example of a computer-readable medium 426 for media classification. The computer-readable medium is a non-transitory, tangible computer-readable medium 426. The computer-readable medium 426 may be, for example, RAM, EEPROM, a storage device, an optical disc, and the like. In some examples, the computer-readable medium 426 may be volatile and/or non-volatile memory, such as DRAM, EEPROM, MRAM, PCRAM, memristor, flash memory, and the like. In some implementations, the memory 306 described in connection with FIG. 3 may be an example of the computer-readable medium 426 described in connection with FIG. 4.

The computer-readable medium 426 may include code (e.g., data and/or instructions). For example, the computer-readable medium 426 may include classification instructions 428 and/or media data 430. The media data 430 may be data corresponding to media. For example, the media data 430 may include text and/or metadata (e.g., numerical metadata).

The classification instructions 428 may include code to cause a processor to produce a first result using a first machine learning model and text associated with media. In some examples, the processor may produce the first result (e.g., first set of probability values) as described in relation to FIG. 1, FIG. 2, and/or FIG. 3.

The classification instructions 428 may include code to cause a processor to produce a second result using a second machine learning model and numerical metadata associated with media. In some examples, the processor may produce the second result (e.g., second set of probability values) as described in relation to FIG. 1, FIG. 2, and/or FIG. 3.

The classification instructions 428 may include code to cause a processor to produce a third result using a third machine learning model, the first result, and the second result. The first result, the second result, and the third result may include probability values corresponding to a movie class, a music class, a voice class, an advertisement class, and a sports class. In some examples, the processor may produce the third result (e.g., first set of probability values) as described in relation to FIG. 1, FIG. 2, and/or FIG. 3.

In some examples, the classification instructions 428 may include code to cause the processor to select the movie class, the music class, the voice class, the advertisement class, or the sports class based on the third result. For instance, the processor may select the class based on the probability values as described in relation to FIG. 1, FIG. 2, and/or FIG. 3.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of techniques and structures are described herein, the techniques and structures are not limited to the examples. Variations of the examples described herein may be implemented within the scope of the disclosure. For example, operations, functions, aspects, or elements of the examples described herein may be omitted or combined.

1. A method, comprising:
analyzing text associated with media using a first machine learning model to produce a first result;
analyzing numerical metadata associated with the media using a second machine learning model to produce a second result; and
inputting the first result and the second result to a third machine learning model to determine a classification of the media.

2. The method of claim 1, wherein analyzing the text comprises:
removing punctuation and words from the text;
mapping the text to a vector of numerical values; and
inputting the vector of numerical values to the first machine learning model to produce the first result.

3. The method of claim 2, wherein the first result comprises first probability values corresponding to classes of media.

4. The method of claim 1, wherein analyzing the numerical metadata comprises:
extracting the numerical metadata; and
inputting the numerical metadata to the second machine learning model to produce the second result.

5. The method of claim 4, wherein the first result comprises first probability values and the second result comprises second probability values corresponding to a same set of classes.

6. The method of claim 1, wherein inputting the first result and the second result comprises inputting first probability values and second probability values to the third machine learning model.

7. The method of claim 6, wherein the first probability values and the second probability values each include values corresponding to a movie class, a music class, a voice class, an advertisement class, a news class, and a sports class.

8. The method of claim 1, wherein the third machine learning model produces third probability values, and wherein determining the classification comprises selecting a class corresponding to a greatest value of the third probability values.

9. The method of claim 1, wherein the first machine learning model is trained based on training text associated with a set of training media and labels corresponding to the set of training media, and wherein the second machine learning model is trained based on training numerical metadata associated with the set of training media and the labels corresponding to the set of training media.

10. The method of claim 1, wherein the third machine learning model is trained with first training probability values, second training probability values, and labels corresponding to a set of training media.

11. An apparatus, comprising:
a memory; and
a processor coupled to the memory, wherein the processor is to:
determine a first set of probability values using a first machine learning model based on text associated with media;
extract numerical metadata associated with the media;
determine a second set of probability values using a second machine learning model based on the numerical metadata; and
determine a classification of the media using a third machine learning model based on the first set of probability values and the second set of probability values.

12. The apparatus of claim 11, wherein the numerical metadata includes data indicating duration, sample rate, video presence, bit depth, and number of channels of the media.

13. The apparatus of claim 11, wherein the processor is to select an audio setting based on the classification.

14. A non-transitory tangible computer-readable medium storing executable code, comprising:
code to cause a processor to produce a first result using a first machine learning model and text associated with media;
code to cause the processor to produce a second result using a second machine learning model and numerical metadata associated with the media; and
code to cause the processor to produce a third result using a third machine learning model, the first result, and the second result, wherein the first result, the second result, and the third result comprise probability values corresponding to a movie class, a music class, a voice class, an advertisement class, and a sports class.

15. The computer-readable medium of claim 14, further comprising code to cause the processor to select the movie class, the music class, the voice class, the advertisement class, or the sports class based on the third result.
